(19) United States
(12) Patent Application Publication
(10) Pub. No.: US 2017/0286587 A1
(43) Pub. Date: Oct. 5, 2017

(54) SYSTEMS AND METHODS FOR CREATING BLOCK CONSTRAINTS IN INTEGRATED CIRCUIT DESIGNS

(71) Applicant: FREESCALE SEMICONDUCTOR INC., AUSTIN, TX (US)

(72) Inventors: UZI MAGINI, HADERA (IL); INBAR NEEMAN, PETACH-TIQVA (IL); ILAN COHEN, AUSTIN, TX (US); ALON DVIR, RAANANA (IL)

(73) Assignee: FREESCALE SEMICONDUCTOR INC., AUSTIN, TX (US)

(21) Appl. No.: 15/086,948

(22) Filed: Mar. 31, 2016

(51) Int. Cl. G06F 17/50

(52) U.S. Cl. CPC G06F 17/5081

(57) ABSTRACT

Methods for generating constraints associated with an integrated circuit design are provided. The method includes identifying, with a processor, a plurality of paths based on a floor-plan data set, each of the paths specifying a first block, a second block, and a first interconnect between the first block and the second block. Cycle time criteria is determined for each of the plurality of paths. A total delay is estimated for each of the plurality of paths based on a block-to-block delay and an in-block delay, wherein the block-to-block delay is based on the interconnect data associated with the first interconnect, and the in-block delay is based on the cell data associated with the first and second blocks.

### TECHNICAL FIELD

Embodiments of the subject matter described herein relate generally to electronic devices, and more particularly, to integrated circuit design constraints, such as those generated in connection with hierarchical system-on-chip designs.

### BACKGROUND

The design complexity for integrated circuits, such system-on-chip (SoC) devices, has increased dramatically in recent years. This complexity can be seen, for example, in the numbers of clocks, clock domains (mostly asynchronous), power domains, and voltage domains. The sheer number of blocks, cells, and the accompanying integration logic can amplify small issues in power, testability, and routing congestion.

The generation of constraints, accompanied by block synthesis, placement, routing, and clock tree checking, can be difficult and time consuming. Accordingly, hierarchical design approaches have become desirable. That is, by grouping blocks and cells into a hierarchy (i.e., blocks containing a number of predefined cells), the verification process can apply a “divide-and-conquer” strategy and greatly improve turn-around time.

Nevertheless, even when hierarchical design is employed, it can take an unsatisfactory length of time to iteratively generate constraints and perform block synthesis. For example, under present conditions, a fifty-million instance design might take up to approximately two weeks per iteration.

Accordingly, there is a need for improved systems and methods for generating block constraints in SOC and other Integrated Circuit (IC) designs.

### BRIEF DESCRIPTION OF THE DRAWINGS

The various embodiments will hereinafter be described in conjunction with the following drawing figures, which are not necessarily drawn to scale, wherein like numerals denote like elements, and wherein:

FIG. 1 depicts a conceptual block diagram of an exemplary hierarchical integrated circuit design useful in describing various embodiments;

FIG. 2 is a conceptual block diagram of a system in accordance with one embodiment;

FIG. 3 is a block diagram of an exemplary computing system configured to carry out the various processes described herein;

FIG. 4 is a flowchart depicting a constraint generation method in accordance with one embodiment; and

FIG. 5 is a flowchart depicting timing analysis in accordance with an exemplary embodiment.

### DETAILED DESCRIPTION

Embodiments of the subject matter described herein generally relate to systems and methods for performing hierarchical integrated circuit design by quickly estimating block-to-block and in-block delays and comparing the sum total of those delays to applicable cycle-time requirements. By determining early on in the design process whether the design meets timing requirements, the overall duration of the design process (from modeling to tape-out) can be significantly reduced. In one embodiment, for example, block-to-block delays for each “path” (between blocks) are estimated based on the length of the interconnect multiplied by some constant, and the in-block delay is estimated by multiplying the number of cells in the block by another constant. In that regard, there is no intention to be bound by any expressed or implied theory presented in the preceding technical field, background, brief summary or the following detailed description. As used herein, the term module or controller refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices.

In addition, those skilled in the art will appreciate that embodiments of the present disclosure may be practiced in conjunction with any number of systems, and that the assemblies described herein are merely various exemplary embodiments of the present disclosure. For the sake of brevity, conventional techniques related to integrated circuits, the integrated circuit design process, computing devices, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

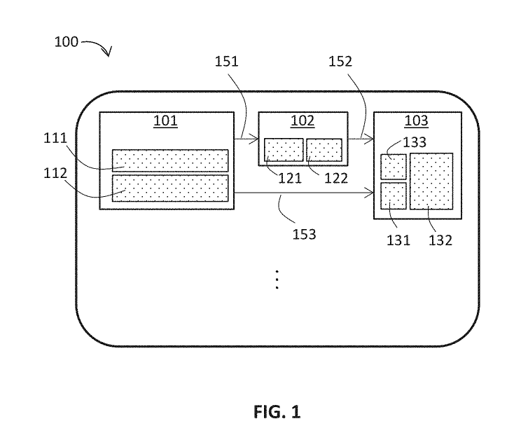

FIG. 1 is a conceptual block diagram depicting an exemplary hierarchical integrated circuit design 100 (hereafter “IC design 100”) useful in describing various embodiments. Generally, the design of a large, complex integrated circuit, such as IC 100, is accomplished hierarchically by specifying a number of “blocks” (e.g., blocks 101, 102, and 103) that are distributed over the available area of IC design 100. Each block 101-103 includes one or more “cells” (also referred to as “standard cells,” “IP cells”, etc.) such as cells 111 and 112 (within block 101), cells 121 and 122 (within block 102), and cells 131-133 (within block 103). As is known in the art, cells (such as cell 111) generally implement low-level functionality, such as a Boolean logic functions (AND, OR, XOR, NAND, etc.) or storage functions (flip-flop, latch, etc.); however, such cells might provide more complicated functionality, such as a full-adder, multiplexer, or the like.

It can be seen that blocks 101-103 effectively “abstract away” the functionality of the individual cells (cells 111-112, 121-122, and 131-133, respectively) that each block contains. The behavior and timing of each cell is generally well-documented and known a priori. As such, the designer can assemble a large scale IC design consisting of millions of individual components without needing to know anything beyond the various inputs, outputs, and behavior of each block 101-103 as a whole.

FIG. 1 also illustrates various interconnects between blocks 101-103, such as interconnect 151 (connecting block 101 to block 102), interconnect 152 (connecting block 101 to block 103), and interconnect 153 (connecting block 101 to block 103). These interconnects 151-153 may be one-way or two-way, depending upon the nature of blocks 101-103. For illustration purposes, interconnects 151-153 in FIG. 1 are shown as one-way, direct electrical connections. Specifically, interconnect 151 directly connects a first output of block 101 to an input of block 102, interconnect 152 directly connects an output of block 102 to a first input of block 103, and interconnect 153 directly connects a second output of block 101 to a second input of block 103. It will be appreciated, however, that the invention is not limited to any number or type of cells, blocks, or interconnects.

The placement of blocks 101-103 and their corresponding cells is often referred to metaphorically as a “floor plan,” the process of creating the layout as “floor planning,” and the resulting data as “floor planning data.” The floor planning data may be a first data set including: block data specifying a plurality of blocks (e.g., 101-103) in IC design 100; cell data specifying one or more cells (e.g., 111-112, 121-122, and 131-133) included in each of the plurality of blocks; and interconnect data specifying one or more electrical interconnects (e.g., 151-153) between the plurality of blocks.

As will be described in further detail below, a number of embodiments described herein make use of what are termed “block-to-block paths” (or simply “paths”). Such paths generally consist of three parts: a first block, a second block, and an interconnect connected therebetween. For example, one path may be defined by block 101, interconnect 153, and block 103. In accordance with one embodiment, block-to-block delays for each “path” (between blocks) may be estimated based on the length of the interconnect multiplied by a first constant, and the in-block delay is estimated by multiplying the number of cells in the block by a second, different constant. In this way, using such estimates prior to block synthesis, the traditionally time-consuming step of generating constraints can be performed with significantly greater efficiency. In one model, for example, it was found that one constraint-generation iteration for a fifty-million instance design took approximately one-tenth the time as traditional methods.

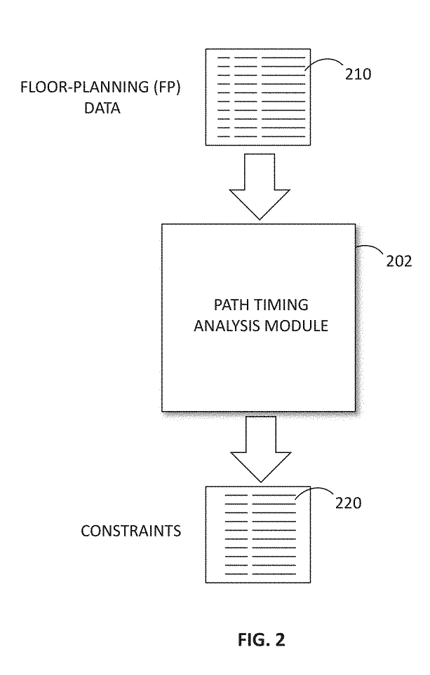

Referring now to the conceptual block diagram shown in FIG. 2 in conjunction with FIG. 1, systems and methods in accordance with the present embodiment employ a path timing analysis module (or simply “module”) 202. Module 202 generates a set of constraints 220 from a set of floor-planning (FP) data 210. As mentioned above, FP data 210 may include block data specifying a plurality of blocks (e.g., 101-103) in IC design 100, cell data specifying one or more cells (e.g., 111-112, 121-122, and 131-133) included in each of the plurality of blocks, and interconnect data specifying one or more electrical interconnects (e.g., 151-153) between the plurality of blocks.

Constraints 220 can include detailed constraints and criteria regarding timing, clocking, and the like, as considered on a more granular level; e.g., on the level of individual cells (e.g., cells 111, 112, 121, 122, 131, and 132 shown in FIG. 1). This data is combined with the block-to-block constraints and criteria.

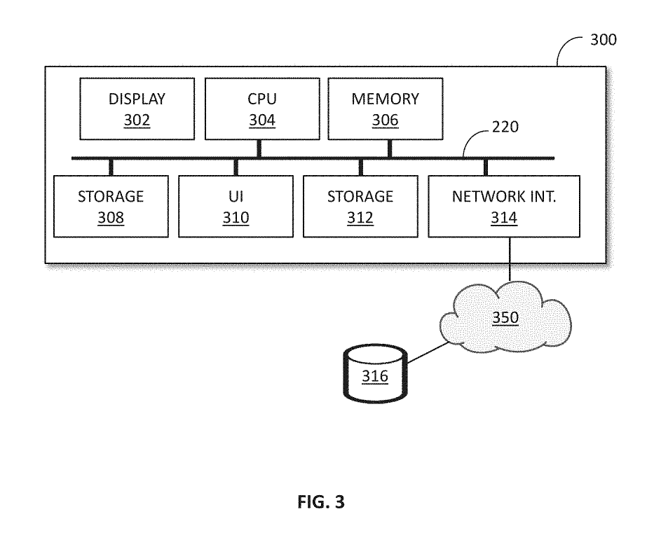

Module 202 may be implemented in a variety of ways using any suitable combination of hardware and/or software. FIG. 3, for example, illustrates a conceptual block diagram of an exemplary computing system 300 configured to carry out the various processes described herein with respect to module 202. In this regard, computing system 300 generally includes a display 302 (e.g., a computer monitor, a touch-screen, or the like), one or more central processing units (CPUs) 304, one or more memory components 306 (e.g., RAM, ROM, etc.), a network interface component 314 (e.g., a WiFi, Ethernet, or other such interface), one or more input/output interfaces 310 (e.g., keyboards, mice, etc.), and storage 312 (e.g., a solid state drive or traditional hard drive). CPU 304 is configured to execute machine readable software instructions (which might correspond to any and all of the various software components described herein). These software instructions may be retrieved from storage 312 or from an outside source, such as a database 316 accessible via a network 350. Similarly, FP data 210 and constraints 220 of FIG. 2 may be stored within database 316, storage 308, or any combination thereof.

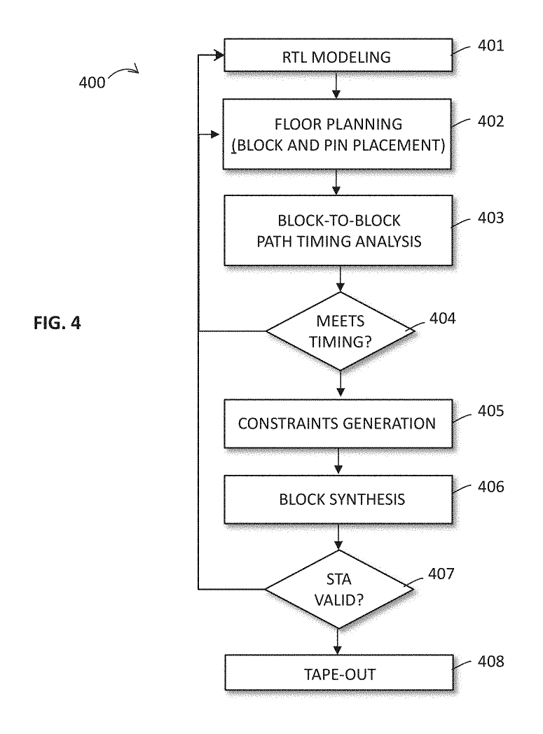

FIG. 4 is a flow-chart depicting a constraint generation method 400 in accordance with one embodiment, and will now be described in detail in conjunction with FIGS. 1-3.

First, at 401, it is assumed that an RTL (register-transfer level) model for the desired IC design 100 is available. As is known in the art, an RTL model is a design abstraction that models a synchronous digital circuit in terms of the flow of digital signals (data) between hardware registers, and the logical operations performed on those signals. RTL abstraction is used in hardware description languages (HDLs), such as Verilog, to create high-level representations of a circuit, from which lower-level representations and ultimately actual wiring can be derived. RTL models are well known in the art, and need not be discussed in detail herein.

Next, at 402, the FP data 210 is produced based on the RTL modeling data from 401. FP data 210 may include block data specifying a plurality of blocks (e.g., 101-103) in IC 100, cell data specifying one or more cells (e.g., 111-112, 121-122, and 131-133) included in each of the plurality of blocks, and interconnect data specifying one or more electrical interconnects (e.g., 151-153) between the plurality of blocks. This data can generally also include other information, such as block names, pin locations, block boundaries, place-in-flow details, and the like. FP data, such as FP data 210, is generally known by those skilled in the art, and also need not be described in detail herein.

Next, in steps 403-405, the functions of path timing analysis module 202 are performed. Briefly, a block-to-block path timing analysis is first performed (403), and a determination is made as to whether the resulting analysis meets certain timing criteria (404). If the timing criteria is met, then processing loops back to steps 401 and or 402 (depending upon the nature of the timing problem). If the timing criteria is not met, then constraints are generated at 406 utilizing block synthesis. Based on the block synthesis, a determination is made as to whether static timing analysis (STA) is valid (407). If not, processing loops back to steps 401 and or 402 as before. If the STA is found to be valid, the design continues to the “tape-out” step 408.

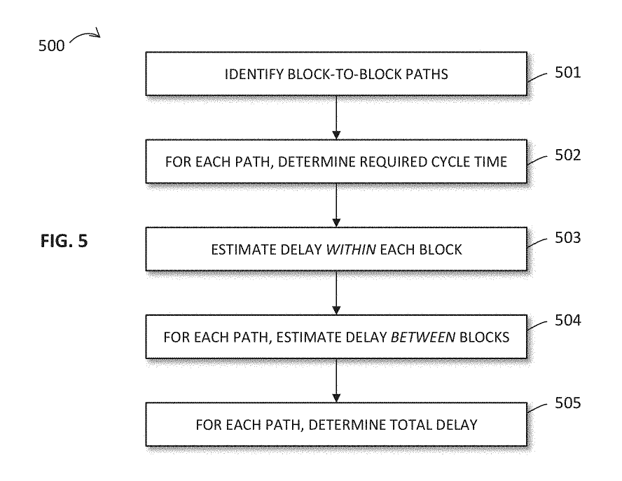

FIG. 5 is a flow-chart depicting a detailed timing analysis process 500 in accordance with an exemplary embodiment. Timing analysis process 500 of FIG. 5 may be used to implement step 403 of FIG. 4.

Initially, at 501, the block-to-block paths are identified for IC design 100 (e.g., by CPU 304). As mentioned above, in an embodiment, such paths generally contain or consist of three parts: a first block, a second block, and an interconnect connected therebetween. For example, one path may be defined by block 101, interconnect 153, and block 103. The block-to-block paths may be stored in any convenient data structure, for example, an associative array of path identifiers combined with corresponding attributes of that path.

Once the block-to-block paths are identified, the required cycle time for each path is determined. For example, it might be determined that the functionality provided by a path including blocks 101 and 103 should take no longer than 30 pico-seconds to perform. It will be appreciated that the times presented are merely given as examples, and are not meant to be limiting. The required cycle time may be specified in any convenient manner, and may be stored in any suitable storage medium, either locally or in a database available over a network.

Next, at 503, the delay within each block is estimated. In one embodiment, for example, this in-block delay is estimated by multiplying the number of cells within the block by some constant or factor. For example, block 101 includes two cells (111 and 112). If the relevant constant were taken to be, for example, 0.5 (pico-seconds/cell), then the in-block delay for block 101 would be computed as 2 * 0.5, or 1.0 pico-seconds. Similarly, the in-block delay for block 103 might be computed as 3 * 0.5 or 1.5 pico-seconds. The combined in-block delay for this path would then be 2.5 pico-seconds. In other embodiments, the system estimates the in-block delay using more complicated methods that nonetheless have relatively low computational complexity as compared to traditional timing analysis. For example, weighting factors may be multiplied by certain types of cells (e.g., cells known to have greater delay), and/or the topology of the cells may be analyzed on some level (i.e., rather than simply considering the scalar number of cells within a block).

At 504, the delay between blocks is estimated. In one embodiment, this step includes multiplying the scalar length of the interconnect by some second predetermined constant or factor. Such length information will generally be known from FP data 210. For example, if it is determined that interconnect 153 is 2 microns in length, and the second predetermined constant is 1.5 (pico-seconds/micron), then the block-to-block delay would then be estimated as 3.0 pico-seconds. In other embodiments, the system estimates the block-to-block delay using more complicated methods that nonetheless have relatively low computational complexity as compared to traditional timing analysis. For example, weighting factors may be multiplied depending upon the nature of the interconnect (e.g., material, width, thickness, shape, etc.)

Next, at 505, the total delay is estimated for each of the paths based on the block-to-block delay and an in-block delay. Thus, in the above example, the total delay would be 2.5+3.0=5.5 pico-seconds. Referring again to FIG. 4, the determination as to whether the block-to-block path satisfies its timing requirements would involve comparing the total delay (5.5 pico-seconds) to the required cycle time determined in step 502 (e.g., 30 pico-seconds) to determine whether the total delay meets some criteria associated with the required cycle time. In one embodiment, for example, the timing is met per step 404 when the total delay is less than or equal to the required cycle time. In another embodiment, the timing is met when the total delay is not greater than a specified time interval by a predetermined margin (e.g., about 5-10%). This concludes timing analysis process 500.

In summary, a method for generating constraints associated with an integrated circuit design has been described. In an embodiment, the method includes receiving a first data set associated with the integrated circuit design. The first data set can contain various different types of data, such as block data specifying a plurality of blocks in the integrated circuit design; cell data specifying one or more cells included in each of the plurality of blocks; and interconnect data specifying one or more electrical interconnects between the plurality of blocks. The method further can further include identifying, with a processor, a plurality of paths based on the first data set. Each path may contain or consist of a first block, a second block, and a first interconnect between the first block and the second block. Cycle time criteria is determined for each of the plurality of paths. A total delay is then computed for each of the plurality of paths based on, for example, a block-to-block delay (determined utilizing the interconnect data associated with the first interconnect) and an in-block delay. (determined utilizing the cell data associated with the first and second blocks). A set of constraints is then generated for the integrated circuit design if the total delay for each of the identified paths meets the corresponding cycle time criteria for that path.

A timing analysis module for generating constraints associated with an integrated circuit design has further been described, as based on floor-planning data associated with the integrated circuit design. In an embodiment, the timing analysis module includes: a processor; a memory configured to store software instructions. When executed by the processor, the software instructions cause the processor to: parse the floor-planning data to determine a plurality of blocks in the integrated circuit design, cell data specifying one or more cells included in each of the plurality of blocks, and interconnect data specifying one or more electrical interconnects between the plurality of blocks; identify a plurality of paths, each of the paths specifying a first block, a second block, and a first interconnect between the first block and the second block; determine cycle time criteria for each of the plurality of paths; estimate a total delay for each of the plurality of paths based on a block-to-block delay and an in-block delay, wherein the block-to-block delay is based on the interconnect data associated with the first interconnect, and the in-block delay is based on the cell data associated with the first and second blocks; generate a set of constraints for the integrated circuit design only if the total delay for each of the identified paths meets the corresponding cycle time criteria for that path.

In accordance with another embodiment, a method for performing, with a processor, timing analysis on integrated circuit floor planning data has been provided. The integrated circuit floor planning data can include (a) block data specifying a plurality of blocks in the integrated circuit design, (b) cell data specifying one or more cells included in each of the plurality of blocks, and (c) interconnect data specifying one or more electrical interconnects between the plurality of blocks. In an embodiment, the method may include: identifying a plurality of paths based on the first data set, each of the paths specifying a first block, a second block, and a first interconnect between the first block and the second block; estimating a total delay for each of the plurality of paths based on a block-to-block delay and an in-block delay, wherein the block-to-block delay is based on the interconnect data associated with the first interconnect, and the in-block delay is based on the cell data associated with the first and second blocks; and determining whether the total delay for each of the identified paths meets a corresponding cycle time criteria for that path.

The foregoing detailed description is merely illustrative in nature and is not intended to limit the embodiments of the subject matter or the application and uses of such embodiments. Any implementation described herein as exemplary is not necessarily to be construed as preferred or advantageous over other implementations. Additionally, there is no intention to be bound by any expressed or implied theory presented in the preceding technical field, background, or the detailed description.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed is:

1. A method for generating constraints associated with an integrated circuit design, the method comprising:
receiving a first data set associated with the integrated circuit design, the first data set including: block data specifying a plurality of blocks in the integrated circuit design; cell data specifying one or more cells included in each of the plurality of blocks; and interconnect data specifying one or more electrical interconnects between the plurality of blocks;
identifying, with a processor, a plurality of paths based on the first data set, each of the paths specifying a first block, a second block, and a first interconnect between the first block and the second block;
determining cycle time criteria for each of the plurality of paths;
estimating a total delay for each of the plurality of paths based on a block-to-block delay and an in-block delay, wherein the block-to-block delay is based on the interconnect data associated with the first interconnect, and the in-block delay is based on the cell data associated with the first and second blocks; and
generating a set of constraints for the integrated circuit design only if the total delay for each of the identified paths meets the corresponding cycle time criteria for that path.

2. The method of claim 1, further including modifying, with the processor, the first data set if it is determined that the total delay for each of the identified paths does not meet the corresponding cycle time criteria for that path.

3. The method of claim 1, wherein the first interconnect has a length specified by the interconnect data, and the block-to-block delay is computed as the length of the first interconnect multiplied by a first predetermined constant.

4. The method of claim 3, wherein the first block includes a first number of cells, the second block includes a second number of cells, and the in-block delay is computed as a second predetermined constant multiplied by the sum of the first number of cells and the second number of cells.

5. The method of claim 1, wherein the cycle time criteria corresponds to whether the total delay is greater than a specified time interval by a predetermined margin.

6. The method of claim 5, wherein the predetermined margin is approximately 10% of the specified time interval.

7. The method of claim 1, wherein the integrated circuit design is a hierarchical silicon-on-chip (SOC) design.

8. The method of claim 1, wherein the first data set is a floor-planning data set that further includes pin placement information for the plurality of blocks.

9. A timing analysis module for generating constraints associated with an integrated circuit design based on floor-planning data associated with the integrated circuit design, the timing analysis module comprising:
a processor;
a memory configured to store software instructions that, when executed by the processor, cause the processor to:
parse the floor-planning data to determine a plurality of blocks in the integrated circuit design, cell data specifying one or more cells included in each of the plurality of blocks, and interconnect data specifying one or more electrical interconnects between the plurality of blocks;
identify a plurality of paths, each of the paths specifying a first block, a second block, and a first interconnect between the first block and the second block;
determine cycle time criteria for each of the plurality of paths;
estimate a total delay for each of the plurality of paths based on a block-to-block delay and an in-block delay, wherein the block-to-block delay is based on the interconnect data associated with the first interconnect, and the in-block delay is based on the cell data associated with the first and second blocks; and
generate a set of constraints for the integrated circuit design only if the total delay for each of the identified paths meets the corresponding cycle time criteria for that path.

10. The timing analysis module of claim 9, wherein the software instructions are further configured to cause the processor to modify the floor-planning data if it is determined that the total delay for each of the identified paths does not meet the corresponding cycle time criteria for that path.

11. The timing analysis module of claim 9, wherein the first interconnect has a length specified by the interconnect data, and the block-to-block delay is computed as the length of the first interconnect multiplied by a first predetermined constant.

12. The timing analysis module of claim 11, wherein the first block includes a first number of cells, the second block includes a second number of cells, and the in-block delay is computed as a second predetermined constant multiplied by the sum of the first number of cells and the second number of cells.

13. The timing analysis module of claim 9, wherein the cycle time criteria corresponds to whether the total delay is greater than a specified time interval by a predetermined margin.

14. The timing analysis module of claim 13, wherein the predetermined margin is approximately 10% of the specified time interval.

15. The timing analysis module of claim 9, wherein the integrated circuit design is a hierarchical silicon-on-chip (SOC) design.

16. The timing analysis module of claim 9, wherein the floor-planning data set that further includes pin placement information for the plurality of blocks.

17. A method for performing, with a processor, timing analysis on integrated circuit floor-planning data including (a) block data specifying a plurality of blocks in the integrated circuit design, (b) cell data specifying one or more cells included in each of the plurality of blocks, and (c) interconnect data specifying one or more electrical interconnects between the plurality of blocks, the method comprising:
identifying a plurality of paths based on the first data set, each of the paths specifying a first block, a second block, and a first interconnect between the first block and the second block;
estimating a total delay for each of the plurality of paths based on a block-to-block delay and an in-block delay, wherein the block-to-block delay is based on the interconnect data associated with the first interconnect, and the in-block delay is based on the cell data associated with the first and second blocks;
determining whether the total delay for each of the identified paths meets a corresponding cycle time criteria for that path.

18. The method of claim 17, wherein the first interconnect has a length specified by the interconnect data, and the block-to-block delay is computed as the length of the first interconnect multiplied by a first predetermined constant.

19. The method of claim 17, wherein the first block includes a first number of cells, the second block includes a second number of cells, and the in-block delay is computed as a second predetermined constant multiplied by the sum of the first number of cells and the second number of cells.

20. The method of claim 17, wherein the cycle time criteria corresponds to whether the total delay is greater than a specified time interval by a predetermined margin, the predetermined margin being approximately 10%.
